(19) United States
(12) Patent Application Publication
(10) Pub. No.: US 2008/0140428 A1
(43) Pub. Date: Jun. 12, 2008

(54) METHOD AND APPARATUS TO ENCODE AND/OR DECODE BY APPLYING ADAPTIVE WINDOW SIZE

(75) Inventors: Ki-hyun Choo, Yongin-si (KR); Eun-mi Oh, Yongin-si (KR); Chang-yong Son, Yongin-si (KR); Jung-hoe Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/949,925

(22) Filed: Dec. 4, 2007

(30) Foreign Application Priority Data
Dec. 11, 2006 (KR) 2006-125663

(51) Int. Cl. G10L 19/00; G10L 19/02

(52) U.S. Cl. 704/500

(57) ABSTRACT

An apparatus to process an audio signal includes an encoder to determine a variable window size of sub bands of a frame of an audio signal, to transform the sub bands according to the variable window size from a first domain to a second domain, to quantize the transformed sub bands, and to multiplex the quantized sub bands and information on the variable window size corresponding the respective sub bands.

### CROSS-REFERENCE TO RELATED APPLICATIONS

This application claims priority from Korean Patent Application No. 10-2006-0125663, filed on Dec. 11, 2006, in the Korean Intellectual Property Office, the disclosure of which is incorporated herein in its entirety by reference.

### BACKGROUND OF THE INVENTION

1. Field of the Invention

The present general inventive concept relates to an apparatus and method of encoding and decoding an audio signal or a speech signal, and more particularly, to an apparatus and method of determining a window size that is to be applied to a transformation performed during encoding/decoding of an audio signal or a speech signal.

2. Description of the Related Art

A transformation is performed in a window size corresponding to a block unit during encoding or decoding of an audio signal or a speech signal in order to significantly improve compression efficiency. If a signal that is to be encoded or decoded is a transient signal, it is desirable to perform the transformation in a small window size since temporal resolution is important. If a signal that is to be encoded or decoded is a stationary signal, it is also desirable to perform the transformation in a window size smaller than a window size for the transient signal in order to reduce a pre-echo.

However, when encoding or decoding an audio signal or a speech signal, a conventional encoding apparatus does not adaptively adjust a window size to perform the transformation according to characteristics of the signal that is to be encoded or decoded. Since a conventional transformation is performed using a limited window size, the compression efficiency or the sound quality is degraded.

### SUMMARY OF THE INVENTION

The present general inventive concept provides a method and apparatus to transform sub bands of a frame of an audio signal by adaptably applying one or more variable window sizes to the sub bands of the frame of the audio signal to improve compression efficiency or the sound quality.

The present general inventive concept provides a method and apparatus to encode and decode an audio signal according to variable window sizes to improve temporal resolution and to reduce a pre-echo.

The present general inventive concept provides a computer readable medium containing computer readable codes as a program to execute a method of an apparatus to process an audio signal, the method including adaptably applying one or more variable window sizes to sub bands of a frame of the audio signal.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing an apparatus to process an audio signal, the apparatus including a transforming unit to transform one or more sub bands of an audio signal according to one or more variable window sizes from a first domain to a second domain.

The apparatus may further include a band dividing unit to divide the audio signal of the first domain into a plurality of frames, and each of the plurality of frames may be divided into the sub bands.

The apparatus may further include a window size determining unit to adjust the one or more variable window sizes with respect to the one or more reference window sizes according to characteristics of the respective sub bands.

The apparatus may further include a window size determining unit to adjust the one or more variable window sizes with respect to each other according to characteristics of the respective second sub bands, and to generate information on the one or more variable window sizes, a quantizing unit to quantize the sub bands, and a multiplexing unit to multiplex the quantized bands and the information to generate a bit stream.

The apparatus may further include a band categorizing unit to categorize the sub bands of the audio signal according to characteristics of the sub bands.

The apparatus may further include a band selecting unit to select one or more first sub bands and one or more second sub bands from the sub bands according to characteristics of the sub bands, wherein the transforming unit may transform the third sub bands according to the one or more reference window sizes and transforms the second sub bands according to the one or more variable window sizes.

The apparatus may further include a window size determining unit to determine the one or more variable window sizes with respect to the second sub bands.

The window size determining unit may generate information on the one or more second sub bands so that the transformed sub bands and the information are multiplexed as a bit stream.

The transforming unit may transform the sub bands according to the one or more variable window sizes when the sub bands have an energy value with respect to a reference energy value.

The transforming unit may transform the sub bands according to the one or more variable window sizes when the sub bands have a predetermined condition representing a characteristic of the sub bands.

The transforming unit may transform the sub bands according to the one or more variable window sizes when the sub bands have a frequency with respect to a reference frequency.

The transforming unit may transform the sub bands according to the one or more variable window sizes when the sub bands have a rate of a transient signal with respect to a threshold.

The transforming unit may transform the sub bands according to the one or more variable window sizes when the sub bands have a characteristic, and transforms another sub bands according to the one or more reference window sizes when the another sub bands do not have the characteristic.

The one or more variable window sizes may be adjusted according to characteristics of the respective sub bands.

The transforming unit may transform another bands of the audio signal according to one or more fixed window sizes from the first domain to the second domain.

The apparatus may further include a unit to determine a characteristic of the audio signal, and the transforming unit may transform the sub bands of the audio signal from the first domain to the second domain according to the one or more variable window sizes and the characteristic of the audio signal.

The transforming unit may transform the one or more sub bands of the audio signal according to the one or more variable window sizes varying with respect to a reference window size.

The transforming unit may transform the one or more sub bands of the audio signal according to the one or more variable window sizes varying with respect to a previous window size of a previous sub band of a previous audio signal

The foregoing and/or other aspects of the present general inventive concept may also be achieved by providing an apparatus to process an audio signal, including a transforming unit to transform sub bands of a frame of an audio signal according to one or more variable window sizes from a first domain to a second domain, according to one or more characteristics of the respective sub bands.

The foregoing and/or other aspects of the present general inventive concept may also be achieved by providing an apparatus to process an audio signal, including an encoder to determine a variable window size of sub bands of a frame of an audio signal, to transform the sub bands according to the variable window size from a first domain to a second domain, to quantize the transformed sub bands, and to multiplex the quantized sub bands and information on the variable window size corresponding the respective sub bands.

The foregoing and/or other aspects of the present general inventive concept may also be achieved by providing an apparatus to process an audio signal, including a decoder to receive a bit stream, to inverse-multiplex the bit stream into sub bands and information on a variable window size to be applied to the respective sub bands, and to inverse-transform the sub bands according to the variable window size.

The foregoing and/or other aspects of the present general inventive concept may also be achieved by providing an apparatus to process an audio signal, including an encoder to determine a variable window size of sub bands of a frame of an audio signal, to transform the sub bands according to the variable window size from a first domain to a second domain, to quantize the transformed sub bands, and to multiplex the quantized sub bands and information on the variable window size corresponding the respective sub bands, and a decoder to receive the bit stream, to inverse-multiplex the bit stream into the sub bands and information on the variable window size to be applied to the respective sub bands, and to inverse-transform the sub bands according to the variable window size.

The foregoing and/or other aspects of the present general inventive concept may also be achieved by providing a method of an apparatus to process an audio signal, the method including transforming one or more first sub bands of an audio signal according to one or more reference window sizes from a first domain to a second domain, and transforming one or more second sub bands of the audio signal according to one or more variable window sizes from the first domain to the second domain.

The foregoing and/or other aspects of the present general inventive concept may also be achieved by providing a method of an apparatus to process an audio signal, the method including transforming sub bands of a frame of an audio signal according to one or more variable window sizes from a first domain to a second domain, according to one or more characteristics of the respective sub bands.

The transforming of the sub bands may include transforming another bands of the audio signal according to one or more fixed window sizes from the first domain to the second domain.

The method may further include determining a characteristic of the audio signal, and the transforming of the sub bands may include transforming the sub bands of the audio signal from the first domain to the second domain according to the one or more variable window sizes and the characteristic of the audio signal.

The transforming of the sub bands may include transforming the one or more sub bands of the audio signal according to the one or more variable window sizes varying with respect to a reference window size.

The transforming of the sub bands may include transforming the one or more sub bands of the audio signal according to the one or more variable window sizes varying with respect to a previous window size of a previous sub band of a previous audio signal

The foregoing and/or other aspects of the present general inventive concept may also be achieved by providing a method of an apparatus to process an audio signal, the method including determining a variable window size of sub bands of a frame of an audio signal, transforming the sub bands according to the variable window size from a first domain to a second domain; quantizing the transformed sub bands, and multiplexing the quantized sub bands and information on the variable window size corresponding the respective sub bands.

The foregoing and/or other aspects of the present general inventive concept may also be achieved by providing a method of an apparatus to process an audio signal, the method including receiving a bit stream, inverse-multiplexing the bit stream into sub bands and information on a variable window size to be applied to the respective sub bands, and inverse-transforming the sub bands according to the variable window size.

The foregoing and/or other aspects of the present general inventive concept may also be achieved by providing a method of an apparatus to process an audio signal, the method including determining a variable window size of sub bands of a frame of an audio signal, transforming the sub bands according to the variable window size from a first domain to a second domain, quantizing the transformed sub bands, and multiplexing the quantized sub bands and information on the variable window size corresponding the respective sub bands, inverse-multiplexing the bit stream into the sub bands and information on the variable window size to be applied to the respective sub bands, and inverse-transforming the sub bands according to the variable window size to form the frame of the audio signal.

The foregoing and/or other aspects of the present general inventive concept may also be achieved by providing a computer readable medium containing computer readable codes as a program to execute a method of an apparatus to process an audio signal, the method including transforming one or more first sub bands of an audio signal according to one or more reference window sizes from a first domain to a second domain, and transforming one or more second sub bands of the audio signal according to one or more variable window sizes from the first domain to the second domain.

The foregoing and/or other aspects of the present general inventive concept may also be achieved by providing a computer readable medium containing computer readable codes as a program to execute a method of an apparatus to process an audio signal, the method including transforming sub bands of a frame of an audio signal according to one or more variable window sizes from a first domain to a second domain, according to one or more characteristics of the respective sub bands.

The foregoing and/or other aspects of the present general inventive concept may also be achieved by providing a computer readable medium containing computer readable codes as a program to execute a method of an apparatus to process an audio signal, the method including determining a variable window size of sub bands of a frame of an audio signal, transforming the sub bands according to the variable window size from a first domain to a second domain; quantizing the transformed sub bands, and multiplexing the quantized sub bands and information on the variable window size corresponding the respective sub bands.

The foregoing and/or other aspects of the present general inventive concept may also be achieved by providing a computer readable medium containing computer readable codes as a program to execute a method of an apparatus to process an audio signal, the method including receiving a bit stream, inverse-multiplexing the bit stream into sub bands and information on a variable window size to be applied to the respective sub bands, and inverse-transforming the sub bands according to the variable window size.

The foregoing and/or other aspects of the present general inventive concept may also be achieved by providing a computer readable medium containing computer readable codes as a program to execute a method of an apparatus to process an audio signal, the method including determining a variable window size of sub bands of a frame of an audio signal, transforming the sub bands according to the variable window size from a first domain to a second domain, quantizing the transformed sub bands, multiplexing the quantized sub bands and information on the variable window size corresponding the respective sub bands, inverse-multiplexing the bit stream into the sub bands and information on the variable window size to be applied to the respective sub bands, and inverse-transforming the sub bands according to the variable window size to form the frame of the audio signal.

The foregoing and/or other aspects of the present general inventive concept may also be achieved by providing an apparatus to process an audio signal, including a dividing unit to divide an audio signal of a time domain into a plurality of frames, and to divide each of the frames into one or more sub bands according to characteristics of the sub bands, and a transforming unit to transform the one or more sub bands of the audio signal from the first domain to the second domain according to one or more variable window sizes.

The one or more variable window sizes may be adjusted according to the characteristics of the second sub bands.

The dividing unit may divide the audio signal of the time domain into a plurality of second frames, divide each of the second frames into a plurality of another sub bands, divide the another sub bands of the second frame into one or more first sub bands and one or more second sub bands according to characteristics of the another sub bands, and the transforming unit may transform the one or more first sub bands of the second frame from the time domain to the frequency domain according to a reference window size, and transform the one or more second sub bands of the second frame from the first domain to the second domain according to one or more second variable window sizes.

The one or more sub bands of the frame may include a first sub band and a second sub band, the one or more variable window sizes may be determined as a first variable window size and a second variable window size according to characteristics of the sub bands, and the transforming unit may transform the first sub band according to the first variable window size and the second sub bands according to the second variable window size.

The characteristics of the sub bands may include one of a transient signal and a stationary signal.

The characteristics of the sub bands may include one of a music signal and a voice signal.

The audio signal may include one or more second sub bands, and the transforming unit may transform the one or more second sub bands of the audio signal from the time domain to the frequency domain according to one or more reference window sizes.

The foregoing and/or other aspects of the present general inventive concept may also be achieved by providing an apparatus to process an audio signal, including a dividing unit to divide an audio signal of a time domain into a plurality of frames, and to divide each of the frames into one or more sub bands, according to characteristics of the sub bands of the frame, and a transforming unit to transform the one or more sub bands of the frame according to one or more variable window sizes variably determined according to the characteristics of the sub bands.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of an encoding apparatus to adaptively apply a window size according to an embodiment of the present general inventive concept;

FIG. 2 is a block diagram of an encoding apparatus to adaptively apply a window size according to another embodiment of the present general inventive concept;

FIG. 3 is a block diagram of an encoding apparatus to adaptively apply a window size according to another embodiment of the present general inventive concept;

FIG. 4 is a block diagram of an encoding apparatus to adaptively apply a window size according to another embodiment of the present general inventive concept;

FIG. 5 is a block diagram of an encoding apparatus to adaptively apply a window size according to another embodiment of the present general inventive concept;

FIG. 6 is a block diagram of a decoding apparatus to adaptively apply a window size according to an embodiment of the present general inventive concept;

FIG. 7 is a block diagram of a decoding apparatus to adaptively apply a window size according to another embodiment of the present general inventive concept;

FIG. 8 is a flowchart of a method of encoding by adaptively applying a window size according to an embodiment of the present general inventive concept;

FIG. 9 is a flowchart of a method of encoding by adaptively applying a window size according to another embodiment of the present general inventive concept;

FIG. 10 is a flowchart of a method of encoding by adaptively applying a window size according to another embodiment of the present general inventive concept;

FIG. 11 is a flowchart of a method of encoding by adaptively applying a window size according to another embodiment of the present general inventive concept;

FIG. 12 is a flowchart of a method of encoding by adaptively applying a window size according to another embodiment of the present general inventive concept;

FIG. 13 is a flowchart of a method of decoding by adaptively applying a window size according to an embodiment of the present general inventive concept; and

FIG. 14 is a flowchart of a method of decoding by adaptively applying a window size according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

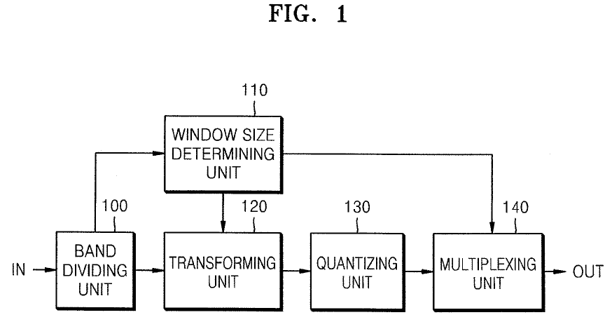

FIG. 1 is a block diagram of an encoding apparatus to adaptively apply a window size according to an embodiment of the present general inventive concept. Referring to FIG. 1, the apparatus includes a band dividing unit 100, a window size determining unit 110, a transforming unit 120, a quantizing unit 130, and a multiplexing unit 140.

The band dividing unit 100 divides an input signal received via an input terminal IN into a plurality of sub bands. Here, the band dividing unit 100 expresses the input signal in the time domain by dividing the input signal into sub bands corresponding to a predetermined frequency band. That is, the input signal of the time domain is divided into a plurality of frames in the band dividing unit 100, and each of the frames is divided and transformed into the plurality of sub bands according to a predetermined frequency band. Examples of a transform used by the band dividing unit 100 include Quadrature Mirror Filterbank (LOT), etc.

The window size determining unit 110 determines a window size that is to be applied to each of the sub bands into which the input signal is divided by the band dividing unit 100.

Here, the window size determining unit 110 determines the window size using the following methods. First, the window size may be determined using an energy value of each sub band. For example, the window size may be determined by comparing an energy value of a sub band corresponding to a previous frame with an energy value of a sub band corresponding to a current frame, comparing an energy value change in corresponding sub bands of the adjacent frames with a predetermined value, comparing energy values of all the sub bands with one another, or comparing an average of energy values of previous sub bands with an energy value of a current sub band. Second, the window size may be determined using an extent to which each sub band changes. Accordingly, the window size is variable to different window size according to one or more characteristics of the corresponding sub bands. Although the above two methods are illustrated, the present general inventive concept is not limited thereto to determine the window size.

The transforming unit 120 transforms a signal of each of the sub bands obtained by the band dividing unit 100 from the time domain to the frequency domain by using the window size of the corresponding sub band determined by the window size determining unit 110. An example of a transform used by the transforming unit 120 may include a Modified Discrete Cosine Transform (MDCT).

The quantizing unit 130 quantizes signals of the respective sub bands that are transformed into the frequency domain by the transforming unit 120.

The multiplexing unit 140 generates a bitstream by multiplexing information regarding the window sizes of the respective sub bands, which are determined by the window size determining unit 110, and the quantizing result, i.e., the quantized signals, received from the quantizing unit 130, and outputs the bitstream via an output terminal OUT.

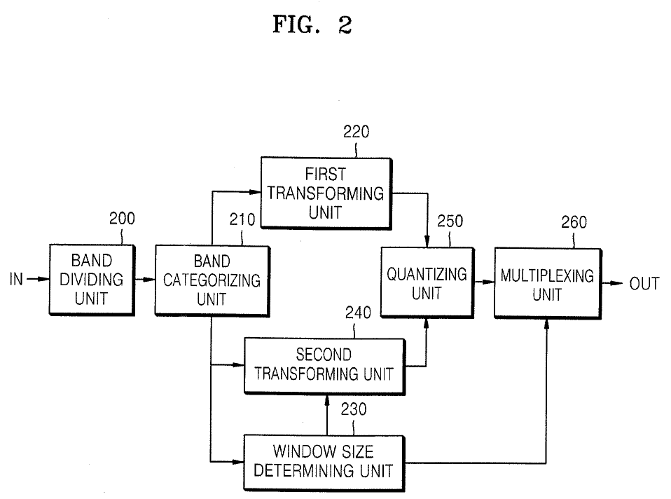

FIG. 2 is a block diagram of an encoding apparatus to adaptively apply a window size according to another embodiment of the present general inventive concept. Referring to FIG. 2 the apparatus includes a band dividing unit 200, a band categorizing unit 210, a first transforming unit 220, a window size determining unit 230, a second transforming unit 240, a quantizing unit 250, and a multiplexing unit 260.

The band dividing unit 200 divides an input signal received via an input terminal IN into a plurality of sub bands. Here, the band dividing unit 200 expresses the input signal in the time domain by dividing the input signal into sub bands corresponding to a predetermined frequency band. That is, the input signal of the time domain is divided into a plurality of frames in the band dividing unit 200, and each of the frames is divided and transformed into the plurality of sub bands according to a predetermined frequency band. Examples of a transform used by the band dividing unit 200 include QMF, LOT, etc.

The band categorizing unit 210 categorizes the sub bands by determining whether they have previously been set as sub bands whose window sizes are to be adjusted. More specifically, the band categorizing unit 210 has previously categorized and set the sub bands of a previous frame into one or more sub bands to which fixed window sizes are respectively applied, and one or more sub bands whose window sizes are to be adjusted, according to a predetermined condition, and categorizes the sub bands of a current frame currently obtained by the band dividing unit 200 according to the predetermined condition. The band categorizing unit 210 inputs the sub bands to which fixed window sizes are respectively applied, to the first transforming unit 220, and inputs the sub bands whose window sizes are to be adjusted, to the second transforming unit 240. The fixed window size may be pre-stored in a memory of the encoding apparatus. The predetermined condition may be a reference frequency band with which each of the sub bands is compared, a characteristic of the respective sub bands or the respective frames, or a condition on the audio signal, for example, a voice signal or a music signal.

The first transforming unit 220 transforms a signal of each of the sub bands, to which fixed window sizes are respectively applied, from a time domain to a frequency domain according to the determination and categorization on the sub bands in the band categorizing unit 210. When transforming the signal of each of the sub bands, the first transforming unit 220 applies a window size that is fixed to a predetermined value as a fixed window size. Here, the fixed window sizes that are to be respectively applied to the sub bands may have been determined to be the same or different from one another. An example of a transform used by the first transforming unit 220 includes an MDCT.

The window size determining unit 230 determines window sizes that are to be respectively applied to the sub bands that are categorized to be the sub bands to which variable or adjustable window sizes are applied.

Here, the window size determining unit 230 determines window sizes as follows. First, the window size may be determined using the energy value of each sub band. For example, the window size may be determined by comparing an energy value of a sub band corresponding to a previous frame with an energy value of a sub band corresponding to a current frame, comparing an energy value change in corresponding sub bands of the adjacent frames with a predetermined value, comparing the energy values of all the sub bands with one another, or comparing an average of energy values of previous sub bands with an energy value of a current sub band. Second, the window size may be determined using an extent to which each sub band changes. Accordingly, the window size is variable or adjusted to different window sizes according to one or more characteristics, for example, the energy value or comparison between the sub bands of adjacent frames, of the corresponding sub bands. Although the above two methods are illustrated, the present general inventive concept is not limited thereto.

The second transforming unit 240 transforms a signal of each of the sub bands that are categorized to be the sub bands whose window sizes are to be adjusted, from a time domain to a frequency domain. When transforming the signal of each of the sub bands, the second transforming unit 240 applies the window size of each of the sub bands, which is determined by the window size determining unit 230 as a variable window size or an adjustable window size. An example of a transform used by the second transforming unit 240 includes an MDCT.

The quantizing unit 250 quantizes signals of the respective sub bands that are transformed to the frequency domain by the first and second transforming units 220 and 240.

The multiplexing unit 260 generates a bitstream by quantizing information regarding the window sizes of the respective sub bands, which are determined by the window size determining unit 230 and the quantizing result, i.e., the quantized signals, received from the quantizing unit 250, and outputs the bitstream via an output terminal OUT.

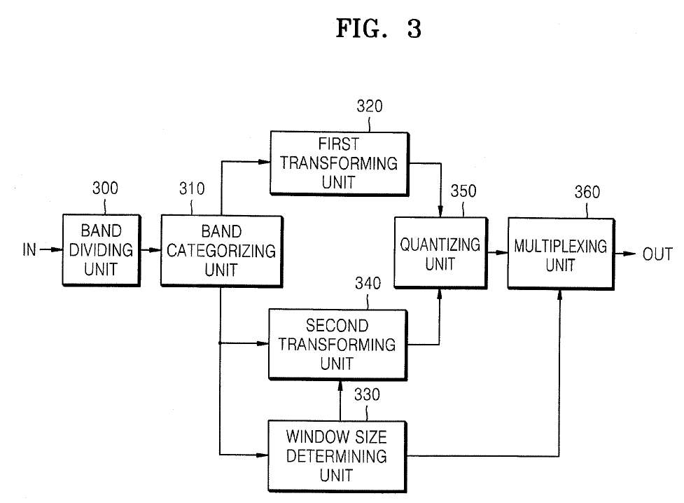

FIG. 3 is a block diagram of an encoding apparatus to adaptively apply a window size according to another embodiment of the present general inventive concept. Referring to FIG. 3, the apparatus includes a band dividing unit 300, a band categorizing unit 310, a first transforming unit 320, a window size determining unit 330, a second transforming unit 340, a quantizing unit 350, and a multiplexing unit 360.

The band dividing unit 300 divides an input signal received via an input terminal IN into a plurality of sub bands. Here, the band dividing unit 300 expresses the input signal in the time domain by dividing the input signal into sub bands corresponding to a predetermine band. That is, the input signal of the time domain is divided into a plurality of frames in the band dividing unit 300, and each of the frames is divided and transformed into the plurality of sub bands according to a predetermined frequency band. Examples of a transform used by the band dividing unit 300 include QMF, LOT, etc.

The band categorizing unit 310 categorizes the sub bands obtained by the band dividing unit 300 by determining whether each of the sub bands is equal to or greater than a predetermined frequency or a reference frequency band. In other words, the band categorizing unit 310 categorizes the sub bands into one or more sub bands corresponding to a low frequency band, and one or more sub bands corresponding to a high frequency band. The band categorizing unit 310 inputs the sub bands that are categorized as the sub bands corresponding to the low frequency band, to the first transforming unit 320, and inputs the sub bands that are categorized as the sub bands corresponding to the high frequency band, to the second transforming unit 340.

The first transforming unit 320 transforms a signal of each of the sub bands that are categorized to correspond to the low frequency band from a time domain to a frequency domain. When transforming the signal of each of the sub bands, the first transforming unit 320 applies a window size that is fixed to a predetermined value. Here, fixed window sizes that are to be respectively applied to the sub bands may have been previously determined to be the same or different from one another. An example of a transform used by the first transforming unit 320 includes an MDCT.

The window size determining unit 330 determines window sizes that are to be respectively applied to the sub bands that are categorized to correspond to the high frequency band by the band categorizing unit 310.

Here, the window size determining unit 330 determines a window size using the following methods. First, the window size may be determined using an energy value of each sub band. For example, the window size may be determined by comparing an energy value of a sub band corresponding to a previous frame with an energy value of a sub band corresponding to a current frame, comparing an energy value change in corresponding sub bands of the adjacent frames with a predetermined value, comparing energy values of all the sub bands with one another, or comparing an average of energy values of previous sub bands with an energy value of a current sub band. Second, the window size may be determined using an extent to which each sub band changes. Although the above two methods are illustrated, the present general inventive concept is not limited thereto.

The second transforming unit 340 transforms a signal of each of the sub bands, which are categorized to correspond to the high frequency band by the band categorizing unit 310, from a time domain to a frequency domain. When transforming the signal of each of the sub bands, the second transforming unit 340 applies the window size of each of the sub bands that is determined by the window size determining unit 330. An example of a transform used by the second transforming unit 340 includes an MDCT.

The quantizing unit 350 quantizes signals of the respective sub bands that are transformed by the first transforming unit 320 and the second transforming unit 340.

The multiplexing unit 360 generates a bitstream by multiplexing information regarding the window sizes of the respective sub bands, which are determined by the window size determining unit 330, and the quantizing result, i.e., the quantized signals, received from the quantizing unit 350, and outputs the bitstream via an output terminal OUT.

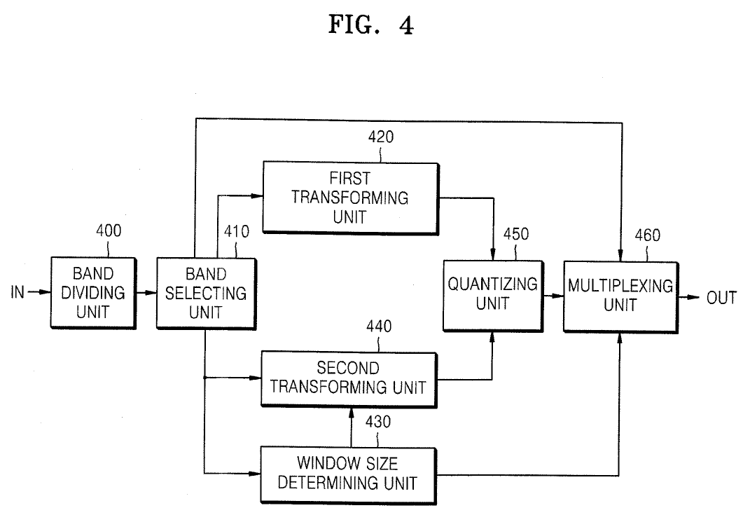

FIG. 4 is a block diagram of an encoding apparatus to adaptively apply a window size according to an embodiment of the present general inventive concept. Referring to FIG. 4, the apparatus includes a band dividing unit 400, a band selecting unit 410, a first transforming unit 420, a window size determining unit 430, a second transforming unit 440, a quantizing unit 450, and a multiplexing unit 460.

The band dividing unit 400 divides an input signal received via an input terminal IN into a plurality of sub bands. Here, the band dividing unit 400 expresses the input signal in a time domain by dividing the input signal into sub bands corresponding to a predetermined frequency band. That is, the input signal of the time domain is divided into a plurality of frames in the band dividing unit 400, and each of the frames is divided and transformed into the plurality of sub bands according to a predetermined frequency band. Examples of a transform used by the band dividing unit 400 include QMF, LOT, etc.

The band selecting unit 410 analyzes the sub bands obtained by the band dividing unit 200, and selects one or more sub bands whose window sizes are to be changed, from among the sub bands. For example, the band selecting unit 410 may select the one or more sub bands in which a rate of transient signals is greater than a threshold. The band selecting unit 410 inputs the selected sub bands whose window sizes are to be changed, to the second transforming unit 440, and the other sub bands to the first transforming unit 420.

The first transforming unit 420 transforms the signal of each of the other sub bands that are not selected by the band selecting unit 410 from a time domain to a frequency domain. When transforming the signal of each of the other sub bands, the first transforming unit 420 applies a window size that is fixed to a predetermined value. Here, window sizes that are to be respectively applied to the other sub bands may have been previously determined to be the same or be different from one another. An example of a transform used by the first transforming unit 420 includes an MDCT.

The window size determining unit 430 determines the window sizes that are to be respectively applied to the selected sub bands whose window sizes are determined to be changed.

Here, the window size determining unit 430 determines a window size using the following methods. First, the window size may be determined using an energy value of each sub band. For example, the window size may be determined by comparing an energy value of a sub band corresponding to a previous frame with an energy of a sub band corresponding to a current frame, comparing an energy value change in corresponding sub bands of the adjacent frames with a predetermined value, comparing energy values of all the sub bands with one another, or comparing an average of energy values of previous sub bands with an energy value of a current sub band. Second, the window size may be determined using an extent to which each sub band changes. Although the two above methods are illustrated, the present general inventive concept is not limited thereto.

The second transforming unit 440 transforms a signal of each of the selected sub bands from a time domain to a frequency domain. When the second transforming unit 440 transforms the signals of the selected sub bands, the window sizes are determined by the window size determining unit 430 to be applied to transform the selected sub bands. An example of a transform used by the second transforming unit 440 is an MDCT.

The quantizing unit 450 quantizes signals of the respective sub bands that are transformed by the first and second transforming units 420 and 440.

The multiplexing unit 460 multiplexes information regarding the sub bands that are selected by the band selecting unit 410, information regarding the window sizes of the respective sub bands, which are determined by the window size determining unit 430, and the quantization result, i.e., the quantized signals, received from the quantizing unit 250 so as to generate a bitstream, and outputs the bitstream via an output terminal OUT.

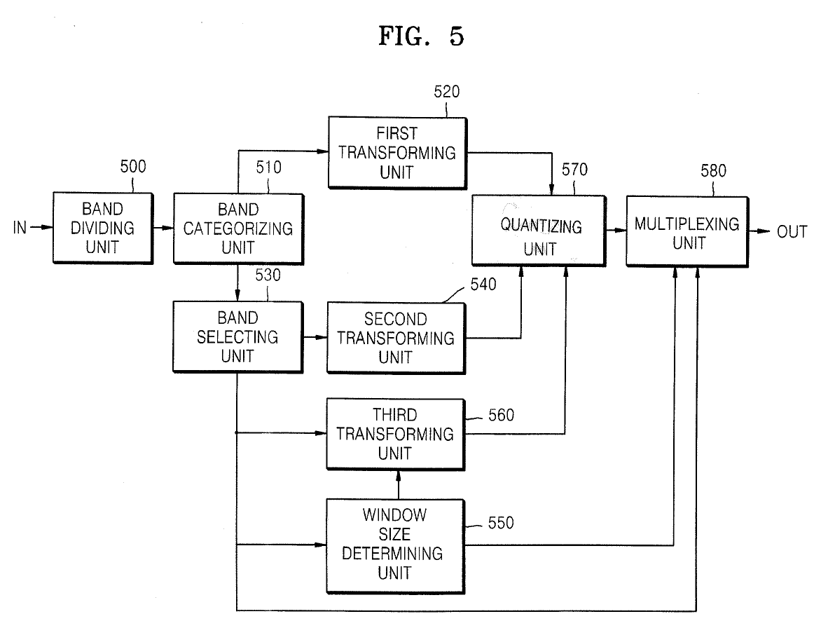

FIG. 5 is a block diagram of an encoding apparatus to adaptively apply a window size according to another embodiment of the present general inventive concept. Referring to FIG. 5, the apparatus includes a band dividing unit 500, a band categorizing unit 510, a first transforming unit 520, a band selecting unit 530, a second transforming unit 540, a window size determining unit 550, a third transforming unit 560, a quantizing unit 570, and a multiplexing unit 580.

The band dividing unit 500 divides an input signal received from an input terminal IN into a plurality of sub bands. Here, the band dividing unit 500 expresses the input signal in the time domain by dividing the input signal into sub bands corresponding to a predetermined frequency band. That is, the input signal of the time domain is divided into a plurality of frames in the band dividing unit 500, and each of the frames is divided and transformed into the plurality of sub bands according to a predetermined frequency band. Examples of a transform used by the band dividing unit 500 include QMF and LOT.

The band categorizing unit 510 categorizes the sub bands received from the band dividing unit 500 by determining whether each of the sub bands is equal to or greater than a predetermined frequency or a reference frequency band. In other words, the band categorizing unit 510 categorizes the sub bands into one or more sub bands corresponding to a low frequency band and one or more sub bands corresponding to a high frequency band. The sub bands corresponding to the low frequency band are input to the first transforming unit 520, and the sub bands corresponding to the band categorizing unit 510 are input to the band selecting unit 530.

The first transforming unit 520 transforms a signal of each of the sub bands corresponding to the low frequency band from a time domain to a frequency domain. When the first transforming unit 520 transforms the signal of each of the sub bands, a window size that is fixed to a predetermined value is applied. Here, the fixed window sizes of the respective sub bands corresponding to the low frequency band may have been previously determined to be the same or be different from one another. An example of a transform used by the first transforming unit 520 is an MDCT.

The band selecting unit 530 analyzes the sub bands corresponding to the high frequency band, and selects one or more sub bands whose window sizes are to be changed, among the sub bands corresponding to the high frequency band. For example, the band selecting unit 530 may select the one or more sub bands in which a rate of transient signals is greater than a threshold. The band selecting unit 530 inputs the selected sub bands, whose window sizes are to be changed, to the third transforming unit 560, and the other sub bands to the second transforming unit 540.

The second transforming unit 540 transforms the signal of each of the other sub bands from a time domain to a frequency domain. When the second transforming unit 540 transforms the signal of each of the sub bands, a window size that is fixed to a predetermined value is applied. Here, window sizes that are to be respectively applied to the other sub bands may have been previously determined to be the same or be different from one another. An example of a transform used by the second transforming unit 540 is an MDCT. The encoding apparatus to adaptively apply the window size, according to an embodiment of the present general inventive concept, may not include the second transforming unit 540, and in this case, the first transforming unit 520 may transform the other sub bands.

The window size determining unit 550 determines the window sizes that are to be respectively applied to the selected sub bands whose window sizes are to be changed.

Here, the window size determining unit 550 determines a window size using the following methods. First, the window size may be determined using an energy value of each sub band. For example, the window size may be determined by comparing an energy value of a sub band corresponding to a previous frame with an energy value of a sub band corresponding to a current frame, comparing an energy value changes in corresponding sub bands of the frames with a predetermined value, comparing energy values of all the sub bands with one another, or comparing an average of energy values of previous sub bands with an energy value of a current sub band. Second, the window size may be determined using an extent to which each sub band changes. Although the two above methods are illustrated, the present general inventive concept is not limited thereto.

The third transforming unit 560 transforms a signal of each of the selected sub bands from a time domain to a frequency domain. When the third transforming unit 560 transforms the signal of each of the selected sub bands, the window sizes, for the respective selected sub bands, which are determined by the window size determining unit 550, are applied. An example of a transform used by the third transforming unit 560 is an MDCT.

The quantizing unit 570 quantizes signals of the respective sub bands that are transformed by the first transforming unit 520, the second transforming unit 540, and the third transforming unit 560.

The multiplexing unit 580 multiplexes information regarding the sub bands selected by the band selecting unit 530, information regarding the window sizes of the respective sub bands, which are determined by the window size determining unit 550, and the quantization result, i.e., the quantized signals, received from the quantizing unit 570 to as to generate a bitstream, and outputs the bitstream via an output terminal OUT.

According to an embodiment of the present general inventive concept, an encoding apparatus to adaptively apply a window size may have similar elements to the encoding apparatus of FIG. 5, that is, may include a band dividing unit, a selecting unit, a band categorizing unit, a fourth transforming unit, a fifth transforming unit, a sixth transforming unit, a window size determining unit, a quantizing unit, and a multiplexing unit among which the band dividing unit, the quantizing unit, and the multiplexing unit correspond to the band dividing unit 500, the quantizing unit 570, and the multiplexing unit 580, respectively, as illustrated in FIG. 5.

However, the band selecting unit may select one or more sub bands from the sub bands received from the band dividing unit according to a comparison of characteristics of the sub bands, for example, a comparison between a frequency band of each sub bands and a reference frequency band, so that the selected one or more sub bands are transmitted to the band categorizing unit, and the other sub bands are transmitted to the fourth transforming unit to apply a fixed window size. The band categorizing unit categorizes the selected sub bands into one or more sub bands to which a fixed window size is applied, and one or more sub bands to which a variable or adjustable window size determined by the window size determining unit is applied. The one or more sub bands to which the fixed window size is applied are transmitted to the fifth transforming unit, and the one or more sub bands to which the variable or adjustable window size is applied are transmitted to the sixth transforming unit. The quantizing unit quantizes transformed signals of the sub bands from the fourth, fifth, and sixth transforming units, and the multiplexing unit generates a bit stream according to the quantized signals and information on the window size of the respective sub bands.

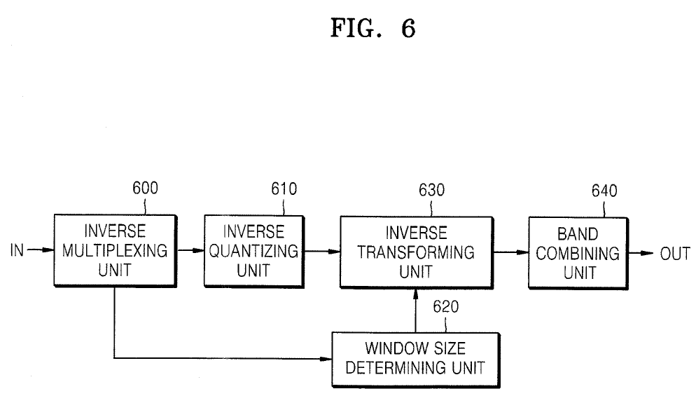

FIG. 6 is a block diagram of a decoding apparatus to adaptively apply a window size according to an embodiment of the present general inventive concept. Referring to FIG. 6, the apparatus includes an inverse multiplexing unit 600, an inverse quantizing unit 610, a window size determining unit 620, an inverse transforming unit 630, and a band combiner 640.

The inverse multiplexing unit 600 receives a bit stream via an input terminal IN, and inversely multiplexes the received bit stream. The bit stream may be received from the encoding apparatus illustrated in FIGS. 1, 2, 3, 4, or 5.

The inverse quantizing unit 610 receives from the inverse multiplexing unit 600 signals of the inversely multiplexed bit stream in units of sub bands, and inversely quantizes the received signals of the sub bands.

The window size determining unit 620 receives from the inverse multiplexing unit 600 information regarding window sizes applied to the respective sub bands, and decodes the information in order to determine the window sizes applied to each of the sub bands.

The inverse transforming unit 630 inversely transforms the inverse quantization result, i.e., the inversely quantized signals of the sub bands, received from the inverse quantizing unit 610 from a frequency domain to a time domain by applying the window sizes of the respective sub bands, which are determined by the window size determining unit 620. An example of a transform used by the inverse transforming unit 630 is an Inverse Modified Discrete Cosine Transform (IMDCT).

The band combiner 640 combines signals of the sub bands, which are inversely transformed by the inverse transforming unit 630, and outputs the combined result via an output terminal OUT. Examples of a transform used by the band combiner 640 include IQMF (Inverse Quadrature Mirror Filterbank) and ILOT (Inverse Lapped Orthogonal Transform).

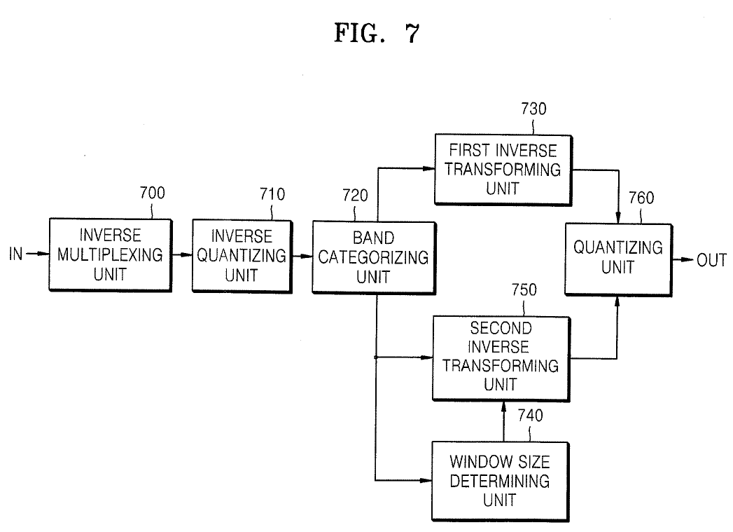

FIG. 7 is a block diagram of a decoding apparatus to adaptively apply a window size according to another embodiment of the present general inventive concept. Referring to FIG. 7, the apparatus includes an inverse multiplexing unit 700, an inverse quantizing unit 710, a band categorizing unit 720, a first inverse transforming unit 730, a window size determining unit 740, a second inverse transforming unit 750, and a band combiner 760.

The inverse multiplexing unit 700 receives a bitstream via an input terminal IN and inversely multiplexes the received bit stream. The bit stream may be received from the encoding apparatus illustrated in FIGS. 1, 2, 3, 4, or 5.

The inverse quantizing unit 710 receives from the inverse multiplexing unit 700 signals of the inversely multiplexed bit stream in units of sub bands, and inversely quantizes the received signals.

The band categorizing unit 720 categorizes the sub bands that are inversely quantized by the inverse quantizing unit 710 by determining whether the sub bands have previously been set as sub bands whose window sizes are to be changed. For example, a frequency band may be divided into a low frequency band lower than a predetermined frequency or a predetermined frequency band and a high frequency band greater than the predetermined frequency or the predetermined frequency band, and only one or more sub bands belonging to the high frequency band may be predetermined to be sub bands whose window sizes are to be changed.

The first inverse transforming unit 730 inversely transforms signals of the inversely quantized sub bands whose window sizes are determined not to be changed by the band categorizing unit 720, which is received from the inverse quantizing unit 710, from a frequency domain to a time domain. When the first inverse transforming unit 730 inversely transforms signals of the respective sub bands, a window size that is fixed to a predetermined value is applied. An example of a transform used by the first inverse transforming unit 730 is an IMDCT.

The window size determining unit 740 receives from the inverse multiplexing unit 700 information regarding a window size applied to each sub band by the encoding unit, decodes the received information, and determines the window size applied to each sub band.

The second inverse transforming unit 750 inversely transforms the inversely quantized signals of the other sub bands whose window sizes are determined to be changed by the band categorizing unit 720, which is received from the inverse quantizing unit 710, from a frequency domain to a time domain. When the second inverse transforming unit 750 inversely transforms signals of the respective sub bands, the window sizes are determined by the window size determining unit 740, and the determined window sizes are applied to transform the respective sub bands. An example of a transform used by the second inverse transforming unit 750 is an IMDCT.

The band combiner 760 combines the signals of the sub bands, which are inversely transformed by the first inverse transforming unit 730 and the second inverse transforming unit 750, and outputs the combined result via an output terminal OUT. Examples of a transform used by the band combiner 760 include IQMF, ILOT, etc.

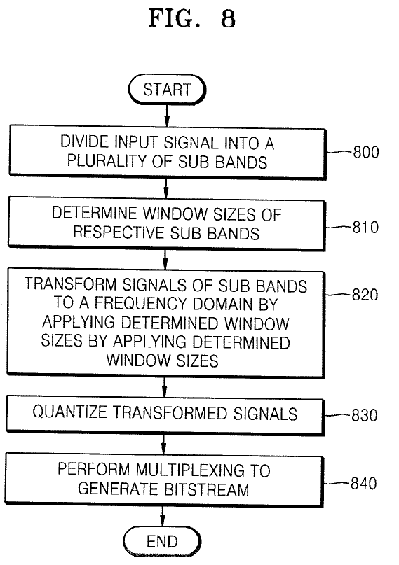

FIG. 8 is a flowchart of a method of encoding by adaptively applying a window size according to an embodiment of the present general inventive concept.

First, an input signal is divided into a plurality of sub bands (operation 800). In operation 800, the input signal is expressed in a time domain by dividing the input signal into sub bands corresponding to a predetermined frequency band. Examples of a transform used in operation 800 include QMF and LOT.

Next, a window size that is to be applied to each of the sub bands obtained in operation 800 is determined (operation 810).

In operation 810, a window size may be determined using the following methods. First, a window size may be determined using an energy value of each sub band. For example, a window size may be determined by comparing the energy value of a sub band corresponding to a previous frame with that of a sub band corresponding to a current frame, comparing an energy value changing in a unit of a frame of each sub band with a predetermined value, comparing the energy values of all the sub bands with one another, or comparing an average of the energy values of previous sub bands with the energy value of a current sub band. Second, a window size may be determined using an extent to which each sub band changes.

Next, signals of the sub bands obtained in operation 800 are transformed from a time domain to a frequency domain, using the window sizes of the sub bands determined in operation 810 (operation 820). An example of a transform used in operation 820 is an MDCT.

The signals of the sub bands, which are transformed to the frequency domain in operation 820, are quantized (operation 830).

Information regarding the window sizes of the sub bands determined in operation 810 and the quantization result obtained in operation 830 are multiplexed so as to generate a bitstream (operation 840).

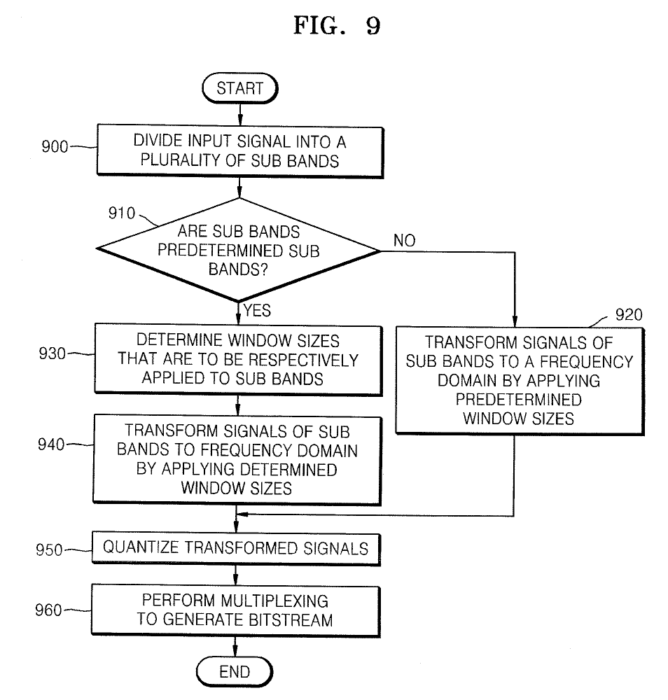

FIG. 9 is a flowchart of an encoding method of adaptively applying a window size according to another embodiment of the present general inventive concept.

First, an input signal is divided into a plurality of sub bands (operation 900). In operation 900, the input signal is expressed in a time domain by dividing the input signal into sub bands corresponding to a predetermined frequency band. Examples of a transform used in operation 900 include QMF and LOT.

Next, it is determined whether the sub bands obtained in operation 900 have previously been set as sub bands whose window sizes are to be changed (operation 910). More specifically, sub bands, whose window sizes are to be changed, and sub bands, to which a fixed window size is to be applied, have already been categorized and set according to a predetermined condition, and in operation 910, the sub bands obtained in operation 900 are categorized according to the predetermined condition.

Next, signals of sub bands that are determined in operation 910 as sub bands to which a fixed window size is to be applied, are transformed from a time domain to a frequency domain (operation 920). When the signal of each of the sub bands is transformed in operation 920, a window size that is fixed to a predetermined value is applied. Here, the fixed window sizes for the respective sub bands may be preset to be the same or be different from one another. An example of a transform used in operation 920 is an MDCT.

Next, window sizes that are to be respectively applied to the sub bands that are categorized in operation 910 as sub bands whose window sizes are to be changed are determined (operation 930).

In operation 930, window sizes may be determined using the following methods. First, a window size may be determined using an energy value of each sub band. For example, a window size may be determined by comparing the energy value of a sub band corresponding to a previous frame with that of a sub band corresponding to a current frame, comparing an energy value changing in a unit of a frame of each sub band with a predetermined value, comparing the energy values of all the sub bands with one another, or comparing an average of the energy values of previous sub bands with the energy value of a current sub band. Second, a window size may be determined using an extent to which each sub band changes.

Next, signals of the other sub bands that are determined in operation 910 as sub bands whose window sizes are to be changed are transformed from a time domain to a frequency domain (operation 940). When the signal of each of the sub bands is transformed in operation 940, the window size of each of the sub bands that is determined in operation 930 is applied. An example of a transform used in operation 940 is an MDCT.

Next, the signals of the sub bands, each being transformed to the frequency domain in operations 920 and 930, are quantized (operation 950).

Next, information regarding the window size of each of the sub bands, which is determined in operation 930, and the quantization result obtained in operation 950 are multiplexed so as to generate a bitstream (operation 960).

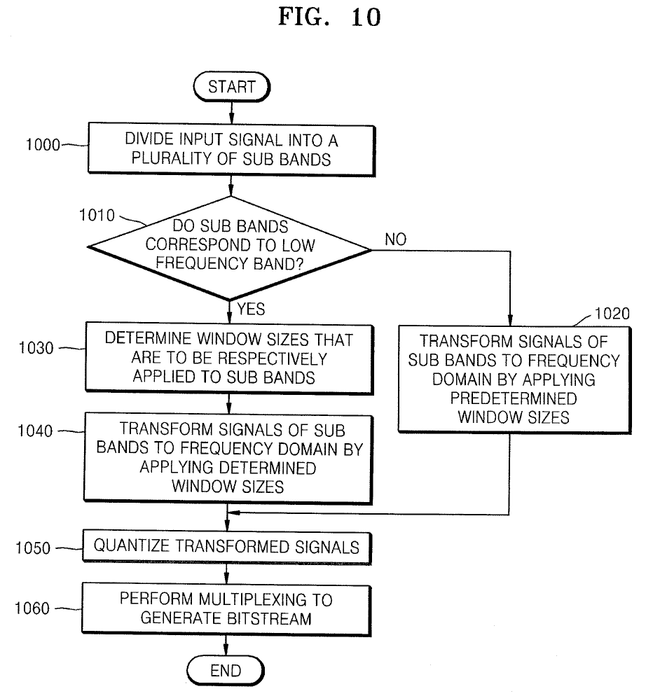

FIG. 10 is a flowchart of an encoding method of adaptively applying a window size according to another embodiment of the present general inventive concept.

First, an input signal is divided into a plurality of sub bands (operation 1000). In operation 1000, the input signal is expressed in a time domain by dividing the input signal into sub bands corresponding to a predetermined frequency band. Examples of a transform used in operation 1000 include QMF and LOT.

The sub bands obtained in operation 1000 are categorized by determining whether each of the sub bands corresponds to a predetermined frequency (operation 1010). In other words, in operation 1010, the sub bands are categorized into sub bands corresponding to a low frequency band and sub bands corresponding to a high frequency band.

Signals of the sub bands that are categorized to correspond to the low frequency band in operation 1010 are transformed from a time domain to a frequency domain (operation 1020). When the signal of each of the sub bands is transformed in operation 1020, a window size that is fixed to a predetermined value is applied. Here, fixed window sizes of the respective sub bands may be set to be the same or be different from another. An example of a transform used in operation 1020 is an MDCT.

Next, a window size that is to be applied to each of the sub bands that are categorized to the high frequency band in operation 1010 is determined (operation 1030).

In operation 1030, window sizes may be determined using the following methods. First, a window size may be determined using an energy value of each sub band. For example, a window size may be determined by comparing the energy value of a sub band corresponding to a previous frame with that of a sub band corresponding to a current frame, comparing an energy value changing in a unit of a frame of each sub band with a predetermined value, comparing the energy values of all the sub bands with one another, or comparing an average of the energy values of previous sub bands with the energy value of a current sub band. Second, a window size may be determined using an extent to which each sub band changes.

Next, signals of the respective sub bands that are categorized to the high frequency band in operation 1010 are transformed from a time domain to a frequency domain (operation 1040). When the signal of each of the sub bands is transformed in operation 1040, the window size of each of the sub bands that is determined in operation 1030 is applied. An example of a transform used in operation 1040 is an MDCT.

Next, the signals of the sub bands that are transformed in operations 1020 and 1040 are quantized (operation 1050).

Next, information regarding the window size of each of the sub bands that is determined in operation 1030 and the quantization result obtained in operation 1050 are multiplexed so as to generate a bitstream (operation 1060).

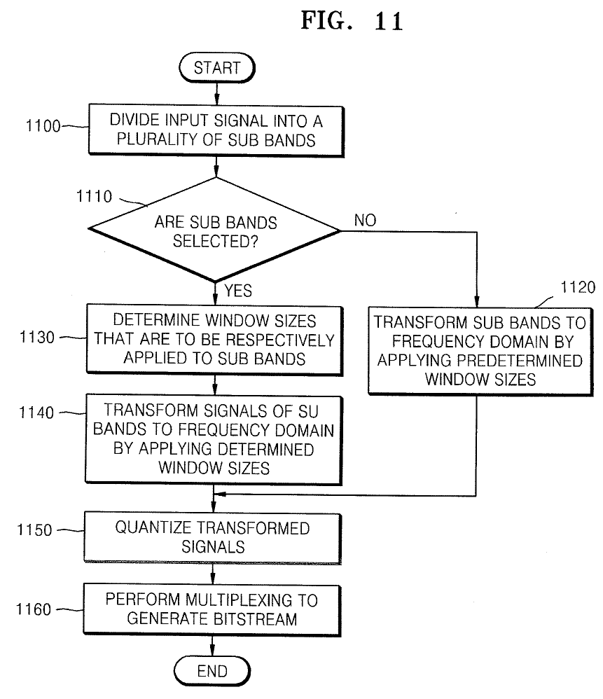

FIG. 11 is a flowchart of an encoding method of adaptively applying a window size according to another embodiment of the present general inventive concept.

First, an input signal is divided into a plurality of sub bands (operation 1100). In operation 1100, the input signal is expressed in a time domain by dividing the input signal into sub bands corresponding to a predetermined frequency band. Examples of a transform used in operation 1100 include QMF and LOT.

Next, the sub bands obtained in operation 1100 are analyzed so as to select sub bands whose window sizes are to be changed, from among the obtained sub bands window size (operation 1110). For example, in operation 1110, sub bands in which the rate of transient signals is greater than a threshold may be selected.

The other sub bands that are not selected in operation 1110 are transformed from a time domain to a frequency domain (operation 1120). When a signal of each of the sub bands is transformed in operation 1120, a window size that is fixed to a predetermined value is applied. Here, the fixed window sizes of the respective sub bands may be set to be the same or be different from one another. An example of a transform used in operation 1120 is an MDCT.

Next, window sizes that are to be respectively applied to the sub bands that are selected in operation 1110 as sub bands whose window sizes are to be changed are determined (operation 1130).

In operation 1130, window sizes may be determined using the following methods. First, a window size may be determined using an energy value of each sub band. For example, a window size may be determined by comparing the energy value of a sub band corresponding to a previous frame with that of a sub band corresponding to a current frame, comparing an energy value changing in a unit of a frame of each sub band with a predetermined value, comparing the energy values of all the sub bands with one another, or comparing an average of the energy values of previous sub bands with the energy value of a current sub band. Second, a window size may be determined using an extent to which each sub band changes.

Next, signals of the respective sub bands that are selected in operation 1110 as sub bands whose window sizes are to be changed are transformed from a time domain to a frequency domain (operation 1140). When the signal of each of the sub bands is transformed in operation 1140, the window size of each of the sub bands that is determined in operation 1130 is applied. An example of a transform used in operation 1140 is an MDCT.

Next, the signals of the sub bands that are transformed in operations 1120 and 1140 are quantized (operation 1150).

Next, information regarding the sub bands selected in operation 1110, information regarding the window size of each of the sub bands that is determined in operation 1130, and the quantization result obtained in operation 1150 are multiplexed so as to generate a bitstream, and the bit stream is output via an output terminal OUT (operation 1160).

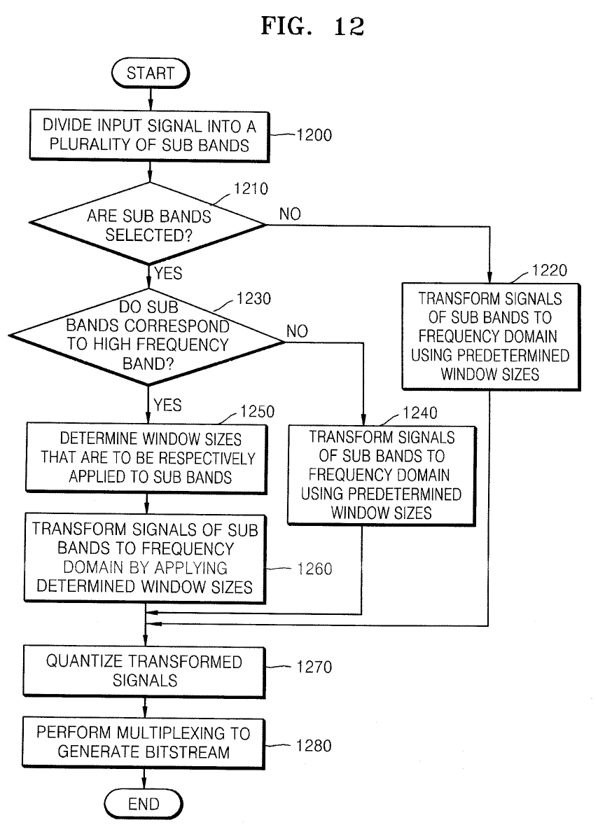

FIG. 12 is a flowchart of an encoding method of adaptively applying a window size according to another embodiment of the present general inventive concept.

First, an input signal is divided into a plurality of sub bands (operation 1200). In operation 1200, the input signal is expressed in a time domain by dividing the input signal into sub bands corresponding to a predetermined frequency band. Examples of a transform used in operation 1200 include QMF and LOT.

Next, the sub bands obtained in operation 1200 are categorized by determining whether each of the sub bands is equal to or greater than a predetermined frequency (operation 1210). In other words, in operation 1210, the sub bands are categorized into sub bands corresponding to a low frequency band and sub bands corresponding to a high frequency band.

Next, signals of the sub bands that are categorized to correspond to the low frequency band in operation 1210 are transformed from a time domain to a frequency domain (operation 1220). When the signal of each of the sub bands is transformed in operation 1220, a window size that is fixed to a predetermined value is applied. Here, the fixed window sizes of the respective sub bands may be set to be the same or be different from one another. An example of a transform used in operation 1220 is an MDCT.

Next, the sub bands that are categorized to correspond to the high frequency band in operation 1210 are analyzed so as to select sub bands whose window sizes are to be changed from the sub bands (operation 1230). For example, in operation 1210, sub bands in which the rate of transient signals is greater than a threshold may be selected.

Next, signals of the respective other sub bands that are not selected in operation 1230 are transformed from a time domain to a frequency domain (operation 1240). When the signal of each of the sub bands is transformed in operation 1240, a window size that is fixed to a predetermined value is applied. Here, the fixed window sizes of the respective sub bands may be set to be the same or be different from one another. An example of a transform used in operation 1240 is an MDCT. An encoding apparatus for adaptively applying a window size, according to an embodiment of the present invention, may skip operation 1240, and in this case, the other sub bands that are not selected in operation 1230 may be transformed in operation 1220.

Next, window sizes that are to be respectively applied to the sub bands that are selected in operation 1230 as sub bands whose window sizes are to be changed, is determined (operation 1250).

In operation 1250, window sizes may be determined using the following methods. First, a window size may be determined using an energy value of each sub band. For example, a window size may be determined by comparing the energy value of a sub band corresponding to a previous frame with that of a sub band corresponding to a current frame, comparing an energy value changing in a unit of a frame of each sub band with a predetermined value, comparing the energy values of all the sub bands with one another, or comparing an average of the energy values of previous sub bands with the energy value of a current sub band. Second, a window size may be determined using an extent to which each sub band changes.

Next, signals of the respective sub bands that are selected in operation 1230 as sub bands whose window sizes are to be changed are transformed from a time domain to a frequency domain (operation 1260). When the signal of each of the sub bands is transformed in operation 1260, the window size of each of the sub bands that is determined in operation 1250 is applied. An example of a transform used in operation 1260 is an MDCT.

Next, the signals of the sub bands that are transformed in operations 1220, 1240, and 1260 are quantized (operation 1270).

Next, information regarding the sub bands selected in operation 1230, information regarding the window size of each of the sub bands that is determined in operation 1250, and the quantization result obtained in operation 1270 are multiplexed so as to generate a bitstream (operation 1280).

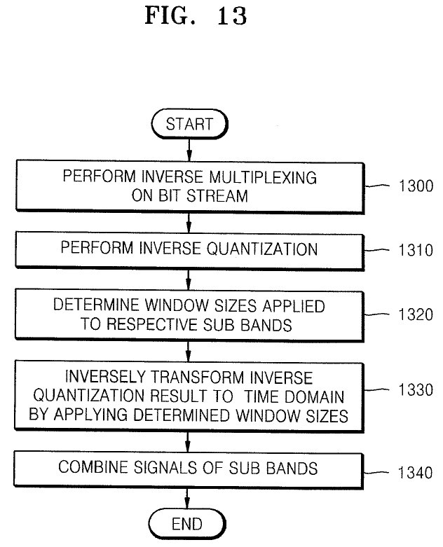

FIG. 13 is a flowchart of a method of decoding by adaptively applying a window size according to another embodiment of the present general inventive concept. First, a bit stream is received from an encoding terminal, and inversely multiplexed (operation 1300).

Next, a result of quantizing each sub band is received from the encoding terminal, and inversely quantized (operation 1310).

Next, information regarding a window size applied to each sub band is received from the encoding terminal, and decoded so as to determine the window size applied to each sub band (operation 1320).

Next, the inverse quantization result obtained in 1310 is inversely transformed from a frequency domain to a time domain (operation 1330). When the signal of each of the sub bands is inversely transformed in operation 1330, the window size of each sub band determined in 1320 is applied. An example of a transform used in operation 1330 is an IMDCT.

Next, signals of the respective sub bands that are inversely transformed in operation 1330 are combined (operation 1340).

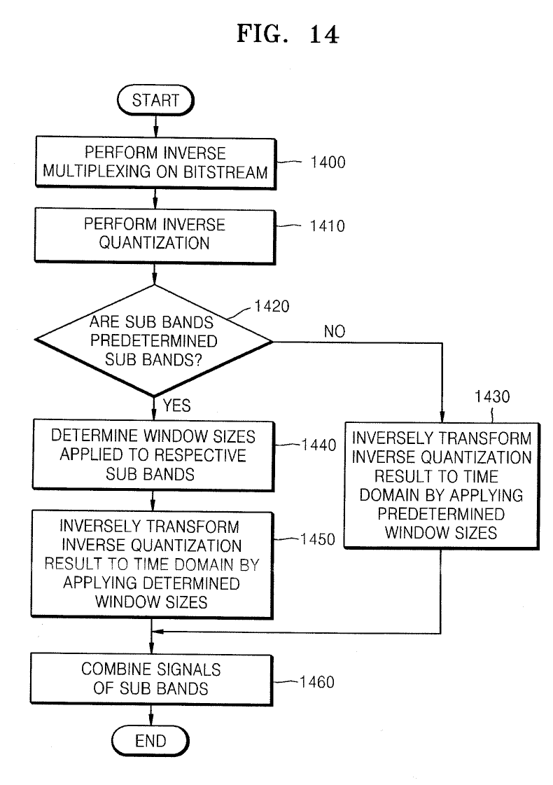

FIG. 14 is a flowchart of a decoding method of adaptively applying a window size according to another embodiment of the present general inventive concept.

First, a bitstream is received from an encoding terminal and inversely multiplexed (operation 1400).

Next, a result of performing quantization in units of sub bands is received from the encoding terminal, and inversely quantized (operation 1410).

Next, the sub bands that are inversely quantized in operation 1410 are categorized by determining whether they have previously been set as sub bands whose window sizes are changed (operation 1420). For example, a frequency band may be divided into a low frequency band less than a predetermined frequency and a high frequency band greater than the predetermined frequency, and only sub bands belonging to the high frequency band may be predetermined as sub bands whose window sizes are to be changed.

Next, the result of performing inverse quantization in operation 1410 is inversely transformed from a frequency domain to a time domain with respect to the sub bands that are categorized in operation 1420 as sub bands whose window sizes are not to be changed (operation 1430). When a signal of each of the sub bands is inversely transformed in operation 1430, a window size that is fixed to a predetermined value is applied. An example of a transform used in operation 1430 is an IMDCT.

Next, information regarding the window size applied to each of the sub bands is received from the encoding terminal, and decoded in order to determine the window size applied to each of the sub bands (operation 1440).

The result in operation 1410 of inversely quantizing the sub bands that are then categorized in operation 1420 as sub bands, whose window sizes are to be changed, is transformed from a frequency domain to a time domain (operation 1450). When a signal of each of the sub bands is inversely transformed in operation 1450, the window size applied to each of the sub bands, which is determined in operation 1440, is applied. An example of a transform used in operation 1450 is an IMDCT.

Next, the signals of the sub bands that are inversely transformed in operations 1430 and 1450 are combined (operation 1460).

The present general inventive concept can also be embodied as computer readable code on a computer readable medium. The computer readable medium may include a computer readable recording medium and a computer readable transmission medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and so on. The computer readable recording medium can also be distributed over network coupled computer systems so that the computer readable code is stored and executed in a distributed fashion. The computer readable transmission medium can transmit carrier waves and signals (e.g., wired or wireless data transmission through the Internet). Also, functional programs, codes, and code segments for accomplishing the present general inventive concept can be easily construed by programmers skilled in the art to which the present invention pertains.

According to an encoding method and apparatus and a decoding method and apparatus for adaptively applying a window size according to the present invention, encoding and decoding are performed by performing a transformation by adaptively applying a window size to each of sub bands according to the characteristics of a signal. Accordingly, it is possible to increase the compression efficiency and improve sound quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to process an audio signal, comprising:
a transforming unit to transform one or more sub bands of the audio signal according to one or more variable window sizes from a first domain to a second domain.

2. The apparatus of claim 1, further comprising:
a band dividing unit to divide the audio signal of the first domain into a plurality of frames,
wherein each of the plurality of frames is divided into the sub bands.

3. The apparatus of claim 1, further comprising:
a window size determining unit to adjust the one or more variable window sizes with respect to one or more reference window sizes according to characteristics of the respective sub bands.

4. The apparatus of claim 1, further comprising:
a window size determining unit to adjust the one or more variable window sizes with respect to each other according to characteristics of the respective sub bands, and to generate information on the one or more variable window sizes;
a quantizing unit to quantize the sub bands; and
a multiplexing unit to multiplex the quantized sub bands and the information to generate a bit stream.

5. The apparatus of claim 1, further comprising:
a band categorizing unit to categorize the audio signal into the one or more sub bands according to one or more characteristics of the respective sub bands.

6. The apparatus of claim 5, further comprising:
a band selecting unit to select one or more first sub bands and one or more second sub bands from the sub bands according to one or more second characteristics of the sub bands,
wherein the transforming unit transforms the first sub bands according to one or more reference window sizes and transforms the second sub bands according to the one or more variable window sizes.

7. The apparatus of claim 6, further comprising:
a window size determining unit to determine the one or more variable window sizes with respect to the second sub bands.

8. The apparatus of claim 7, wherein the window size determining unit generates information on the one or more second sub bands so that the transformed sub bands and the information are multiplexed as a bit stream.

9. The apparatus of claim 1, wherein the transforming unit transforms the sub bands according to the one or more variable window sizes when the sub bands have an energy value with respect to a reference energy value.

10. The apparatus of claim 1, wherein the transforming unit transforms the sub bands according to the one or more variable window sizes when the sub bands have a predetermined condition representing a characteristic of the sub bands.

11. The apparatus of claim 1, wherein the transforming unit transforms the sub bands according to the one or more variable window sizes when the sub bands have a frequency with respect to a reference frequency.

12. The apparatus of claim 1, wherein the transforming unit transforms the sub bands according to the one or more variable window sizes when the sub bands have a rate of a transient signal with respect to a threshold.

13. The apparatus of claim 1, wherein the transforming unit transforms the sub bands according to the one or more variable window sizes when the sub bands have a characteristic, and transforms another sub bands of the audio signal according to one or more reference window sizes when the another sub bands do not have the characteristic.

14. The apparatus of claim 1, wherein the one or more variable window sizes are adjusted according to characteristics of the respective sub bands.

15. The apparatus of claim 1, wherein the transforming unit transforms another bands of the audio signal according to one or more fixed window sizes from the first domain to the second domain.

16. The apparatus of claim 1, further comprising:
a unit to determine a characteristic of the audio signal,
wherein the transforming unit transforms the sub bands of the audio signal from the first domain to the second domain according to the one or more variable window sizes and the characteristic of the audio signal.

17. The apparatus of claim 1, wherein the transforming unit transforms the one or more sub bands of the audio signal according to the one or more variable window sizes varying with respect to a reference window size.

18. The apparatus of claim 1, wherein the transforming unit transforms the one or more sub bands of the audio signal according to the one or more variable window sizes varying with respect to a previous window size of a previous sub band of a previous audio signal.

19. An apparatus to process an audio signal, comprising:
a transforming unit to transform sub bands of a frame of an audio signal according to one or more reference window sizes and one or more variable window sizes from a first domain to a second domain, according to one or more characteristics of the respective sub bands.

20. An apparatus to process an audio signal, comprising:
an encoder to determine a variable window size of sub bands of a frame of an audio signal, to transform the sub bands according to the variable window size from a first domain to a second domain, to quantize the transformed sub bands, and to multiplex the quantized sub bands and information on the variable window size corresponding the respective sub bands.

21. An apparatus to process an audio signal, comprising:
a decoder to receive a bit stream, to inverse-multiplex the bit stream into sub bands and information on a variable window size to be applied to the respective sub bands, and to inverse-transform the sub bands according to the variable window size.

22. An apparatus to process an audio signal, comprising:
an encoder to determine a variable window size of sub bands of a frame of an audio signal, to transform the sub bands according to the variable window size from a first domain to a second domain, to quantize the transformed sub bands, and to multiplex the quantized sub bands and information on the variable window size corresponding the respective sub bands; and
a decoder to receive the bit stream, to inverse-multiplex the bit stream into the sub bands and information on the variable window size to be applied to the respective sub bands, and to inverse-transform the sub bands according to the variable window size.

23. A method of an apparatus to process an audio signal, the method comprising:
transforming one or more first sub bands of an audio signal according to one or more fixed window sizes from a first domain to a second domain; and
transforming one or more second sub bands of the audio signal according to one or more variable window sizes from the first domain to the second domain.

24. A method of an apparatus to process an audio signal, the method comprising:
transforming sub bands of a frame of an audio signal according to one or more variable window sizes from a first domain to a second domain, according to one or more characteristics of the respective sub bands.

25. The method of claim 24, wherein the transforming of the sub bands comprises transforming another bands of the audio signal according to one or more fixed window sizes from the first domain to the second domain.

26. The method of claim 24, further comprising:
determining a characteristic of the audio signal,
wherein the transforming of the sub bands comprises transforming the sub bands of the audio signal from the first domain to the second domain according to the one or more variable window sizes and the characteristic of the audio signal.

27. The method of claim 24, wherein the transforming of the sub bands comprises transforming the one or more sub bands of the audio signal according to the one or more variable window sizes varying with respect to a reference window size.

28. The method of claim 24, wherein the transforming of the sub bands comprises transforming the one or more sub bands of the audio signal according to the one or more variable window sizes varying with respect to a previous window size of a previous sub band of a previous audio signal.

29. A method of an apparatus to process an audio signal, the method comprising:
determining a variable window size of sub bands of a frame of an audio signal;
transforming the sub bands according to the variable window size from a first domain to a second domain;
quantizing the transformed sub bands; and
multiplexing the quantized sub bands and information on the variable window size corresponding the respective sub bands.

30. A method of an apparatus to process an audio signal, the method comprising:
receiving a bit stream;
inverse-multiplexing the bit stream into sub bands and information on a variable window size to be applied to the respective sub bands; and
inverse-transforming the sub bands according to the variable window size.

31. A method of an apparatus to process an audio signal, the method comprising:
determining a variable window size of sub bands of a frame of an audio signal, transforming the sub bands according to the variable window size from a first domain to a second domain, quantizing the transformed sub bands, and multiplexing the quantized sub bands and information on the variable window size corresponding the respective sub bands; and
inverse-multiplexing the bit stream into the sub bands and information on the variable window size to be applied to the respective sub bands, and inverse-transforming the sub bands according to the variable window size to form the frame of the audio signal.

32. A computer readable medium containing computer readable codes as a program to execute a method of an apparatus to process an audio signal, the method comprising:
transforming one or more sub bands of the audio signal according to one or more variable window sizes from a first domain to a second domain.

33. A computer readable medium containing computer readable codes as a program to execute a method of an apparatus to process an audio signal, the method comprising:
determining a variable window size of sub bands of a frame of an audio signal;
transforming the sub bands according to the variable window size from a first domain to a second domain;
quantizing the transformed sub bands; and
multiplexing the quantized sub bands and information on the variable window size corresponding the respective sub bands.

34. A computer readable medium containing computer readable codes as a program to execute a method of an apparatus to process an audio signal, the method comprising:
receiving a bit stream;
inverse-multiplexing the bit stream into sub bands and information on a variable window size to be applied to the respective sub bands; and
inverse-transforming the sub bands according to the variable window size.

35. A computer readable medium containing computer readable codes as a program to execute a method of an apparatus to process an audio signal, the method comprising:
determining a variable window size of sub bands of a frame of an audio signal, transforming the sub bands according to the variable window size from a first domain to a second domain, quantizing the transformed sub bands, and multiplexing the quantized sub bands and information on the variable window size corresponding the respective sub bands; and
inverse-multiplexing the bit stream into the sub bands and information on the variable window size to be applied to the respective sub bands, and inverse-transforming the sub bands according to the variable window size to form the frame of the audio signal.

36. An apparatus to process an audio signal, comprising:
a dividing unit to divide an audio signal of a time domain into a plurality of frames, and to divide each of the frames into one or more sub bands according to characteristics of the sub bands; and
a transforming unit to transform the one or more sub bands of the audio signal from the time domain to the frequency domain according to one or more variable window sizes.

37. The apparatus of claim 36, wherein the one or more variable window sizes are adjusted according to the characteristics of the sub bands.

38. The apparatus of claim 36, wherein:
the dividing unit divides the audio signal of the time domain into a plurality of second frames, and divides each of the second frames into a plurality of another sub bands, to divide the another sub bands of the second frame into one or more first sub bands and one or more second sub bands according to characteristics of the another sub bands; and
the transforming unit transforms the one or more first sub bands of the second frame from the time domain to the frequency domain according to a reference window size, and transforms the one or more second sub bands of the second frame from the first domain to the second domain according to one or more second variable window sizes.

39. The apparatus of claim 36, wherein:
the one or more sub bands of the frame comprises a first sub band and a second sub band;
the one or more variable window sizes are determined as a first variable window size and a second variable window size according to characteristics of the sub bands; and
transforming unit transforms the first sub band according to the first variable window size and the second sub bands according to the second variable window size.

40. The apparatus of claim 36, wherein the characteristics of the sub bands comprise one of a transient signal and a stationary signal.

41. The apparatus of claim 36, wherein the characteristics of the sub bands comprise one of a music signal and a voice signal.

42. The apparatus of claim 36, wherein:
the audio signal comprises one or more second sub bands; and
the transforming unit transforms the one or more second sub bands of the audio signal from the time domain to the frequency domain according to one or more reference window sizes.

43. An apparatus to process an audio signal, comprising:
a dividing unit to divide an audio signal of a time domain into a plurality of frames, and to divide each of the frames into one or more sub bands according to characteristics of the sub bands of the frame; and
a transforming unit to selectively transform the sub bands of the frame according to one or more variable window sizes variably determined according to the characteristics of the sub bands.

44. The apparatus of claim 43, wherein:
the one or more sub bands comprises a first sub band and a second sub band; and
the transforming unit transforms the first sub band according to a reference window size and transforms the second sub band according to the one or more variable window sizes.

45. The apparatus of claim 43, wherein:
the one or more sub bands comprises a first sub band and a second sub band; and
the transforming unit selectively transforms the first sub band according to a reference window size and selectively transforms the second sub band according to the one or more variable window sizes.
